(19) United States
(12) Patent Application Publication
(10) Pub. No.: US 2011/0041772 A1
(43) Pub. Date: Feb. 24, 2011

(54) Stabilized pet dish and method therefor

(76) Inventor: Drake Hargrove, Havelock, NC (US)

Correspondence Address: MArk Taylor, 907 W Haven Blvd, Morehead City, NC, 28557, US

(21) Appl. No.: 12/583,641

(22) Filed: Aug. 24, 2009

(51) Int. Cl. A01K 5/01; A47G 29/00

(52) U.S. Cl. 119/61.57; 248/154

(57) ABSTRACT

A vessel for holding and presenting solids, liquids or both, including a vessel body having a base portion and at least one wall member extending from the base portion and defining at least one cavity for containing solids, liquids or both; a stabilizer including a stabilizer body for ground engagement; and a fastener assembly for releasably retaining the body and the stabilizer in a mated relationship, the fastener including a first fastener portion mounted to the vessel body and a second fastener portion mounted to the stabilizer in a configuration for mating with the first fastener portion when the second fastener portion is closely adjacent a ground surface with the stabilizer body extending into the ground.

### BACKGROUND OF THE INVENTION

The present invention relates broadly to apparatus and methods for facilitating feeding and nourishing animals such as pets and, more particularly, to a stabilized pet dish that includes an anti-tip feature for outdoor use.

It is generally good practice to provide pet animals such as dogs with a water dish outside. Especially desired in hot weather, a dog's need for water can be satisfied without bringing the dog inside. Further, some dogs actually live outdoors, some in fenced enclosures containing a conventional dog house. With or without an enclosure, the need to keep a water dish, food dish or both near a dog's habitat is important for the wellbeing of the animal. One of the problems with leaving conventional dog or pet dishes adjacent a dog's habitat is that the dog or other animal can easily upend the dish, thereby spilling its contents. If the contents are dry food, the spillage would make little difference to the dog who would merely eat the dry food from the ground. On the other hand, if the spillage involves water, the water is irretrievable as it would likely soak into the ground.

Attempts have been made in the past to apply multiple spikes to the bottom of a dog dish so that the spikes can be driven into the ground to prevent upending of the dish. Examples of such structure are disclosed in U.S. Pat. No. 3,202,181 to Jones and US Patent Publication No. 2007/0266952 to Cruse. Among disadvantages of this type of structure is the possible difficulty in removing the dish from the ground for refilling, grooming the area around the dish or for dish cleaning. Further, driving the dish into the ground with the dish full of water could be a difficult task and would likely result in spillage of the water or the contents of the dish.

Accordingly, there exists a need for a pet water dish for use outdoors that can be anchored to the ground in an easy and efficient manner and can also be removed in a likewise easy and efficient manner.

### SUMMARY OF THE INVENTION

It is accordingly an object of the present invention to provide a pet dish for outdoor use which may be selectively anchored to the ground.

It is another object of the present invention to provide such a pet dish that is detachable from the anchor, wherein the anchor may remain in the ground and be out of the way for yard grooming.

It is another object of the present invention to provide such a pet dish wherein the pet dish may be readily attached or detached from an anchor as necessary.

It is another object of the present invention to provide a method for stabilizing a pet dish on the ground wherein the pet dish may be readily attached or detached from an anchor as necessary.

To those ends, the present invention is directed to a vessel for holding and presenting solids, liquids or both. The vessel includes a vessel body having a base portion and at least one wall member extending from the base portion and defining at least one cavity for containing solids, liquids or both. A stabilizer including a stabilizer body is provided for ground engagement. Also included is a fastener assembly for releasably retaining the body and the stabilizer in a mated relationship, the fastener assembly includes a first fastener portion mounted to the vessel body and a second fastener portion mounted to the stabilizer in a configuration for mating with the first fastener portion when the second fastener portion is closely adjacent a ground surface with the stabilizer body extending into the ground.

It is preferred that the first fastener portion is formed with at least one wall defining a receiving chamber and a cover for covering the receiving chamber. The cover is formed with a keyway therein, and the second fastener body portion includes at least one boss projecting therefrom and configured for selective engagement with the keyway formed in the cover of the first fastener portion for selective retention of the vessel and the stabilizer in a mated relationship.

Preferably, the first fastener portion includes a receiving chamber formed therein and the second fastener portion includes a body portion configured for receipt in the receiving chamber. The receiving chamber is configured for selective retention of the body portion in a mated relationship therewith. It is preferred that the first fastener portion is formed with at least one wall defining the receiving chamber, with the at least one wall being formed with at least one slot therein and the second fastener body portion includes at least one boss projecting therefrom and configured for selective engagement with the at least one slot formed in the at least one wall of the first fastener portion for selective retention of the vessel and the stabilizer in a mated relationship.

It is further preferred that the first fastener portion and the second faster portion are configured for engagement with one another by relative rotational motion of the first fastener portion and the second fastener portion between a first position wherein the first fastener portion is engaged with the second fastener portion and a second position wherein the first fastener portion and the second fastener portion are retained in a mated relationship, thereby retaining the vessel and the stabilizer in a mated relationship.

It is preferred that the first fastener portion and the second faster portion are configured for relative rotational motion of about ¼ of a fill 360 degree rotation to about ½ of a full 360 degree rotation of the vessel with respect to the stabilizer and thereby the first fastener portion with respect to the second fastener portion that results in the first fastener portion and the second fastener portion experiencing relative movement between a first position wherein the first fastener portion is engaged with the second fastener portion and a second position wherein the first fastener portion and the second fastener portion are retained in a mated relationship, thereby retaining the vessel and the stabilizer in a mated relationship.

According to another preferred embodiment of the present invention, the first fastener portion includes at least one wall forming a receiving chamber therein. The at least one wall is threaded. The second fastener portion includes a fastener body being formed with threads operationally corresponding to the threads formed on the receiving chamber, with the receiving chamber being configured for selective retention of the fastener body in a threadedly mated relationship therewith.

According to another preferred embodiment of the present invention, the fastener assembly includes a first fastener portion having a receiving portion formed thereon and the second fastener portion includes a corresponding member configured for receipt by the receiving portion. At least one magnet is disposed on at least one of the receiving portion and the corresponding member, and wherein at least one of the receiving portion and the corresponding member includes a magnetically attractive element for selective retention of the receiving portion in a magnetically mated relationship with the corresponding member.

In other terms and according to another preferred embodiment of the present invention, a pet dish is provided for holding and presenting pet-related items, the pet dish being generally for outdoor disposition. The pet dish includes a dish body having a base portion and at least one wall member extending from the base portion and defining at least one cavity for containing pet related items, A support member is provided and includes a generally elongate body for penetrating ground engagement.

A fastener assembly is provided for releasably retaining the dish and the support member in a mated relationship, with the fastener including a first fastener portion mounted to the dish and a second fastener portion mounted to the support member in a configuration for mating with the first fastener portion when the second fastener portion is closely adjacent a ground surface with the support member extending into the ground.

It is preferred that the first fastener portion is formed with at least one wall defining a receiving chamber and a cover for covering the receiving chamber. The cover is formed with a keyway therein, and the second fastener body portion includes at least one boss projecting therefrom and configured for selective engagement with the keyway formed in the cover of the first fastener portion for selective retention of the vessel and the stabilizer in a mated relationship.

Preferably, the fastener assembly includes a first fastener portion having a receiving chamber formed therein and the second fastener portion includes a body portion configured for receipt in the receiving chamber, with the receiving chamber configured for selective retention of the body portion in a mated relationship therewith. It is preferrred that the first fastener portion is formed with at least one wall defining the receiving chamber, with the at least one wall being formed with at least one slot therein and the second fastener body portion at least one boss projecting therefrom and configured for selective engagement with the at least one slot formed in the at least one wall of the first fastener portion for selective retention of the vessel and the stabilizer in a mated relationship.

It is further preferred that the first fastener portion and the second faster portion are configured for engagement with one another by relative rotational motion of the first fastener portion and the second fastener portion between a first position wherein the first fastener portion is engaged with the second fastener portion and a second position wherein the first fastener portion and the second fastener portion are retained in a mated relationship, wherein the vessel and the stabilizer are retained in a mated relationship.

Preferably, the first fastener portion and the second faster portion are configured for relative rotational motion of about ¼ of a full 360 degree rotation to about ½ of a full 360 degree rotation between the vessel and the stabilizer and thereby the first fastener portion and the second fastener portion that results in the first fastener portion and the second fastener portion experiencing relative movement between a first position wherein the first fastener portion is engaged with the second fastener portion and a second position wherein the first fastener portion and the second fastener portion are retained in a mated relationship, thereby retaining the dish and the support member in a mated relationship.

According to another preferred embodiment of the present invention, the fastener assembly includes a first fastener portion having at least one wall forming a receiving chamber therein, with the at least one wall being threaded. The second fastener portion includes a fastener body being formed with threads operationally corresponding to the threads formed on the receiving chamber, with the receiving chamber configured for selective retention of the fastener body in a threadedly mated relationship therewith.

According to another preferred embodiment of the present invention, the fastener assembly includes a first fastener portion having a receiving portion formed thereon. The second fastener portion includes a corresponding member configured for receipt by the receiving portion, with at least one magnet being disposed on at least one of the receiving portion and the corresponding member. At least one of the receiving portion and the corresponding member includes a magnetically attractive element for selective retention of the receiving portion in a magnetically mated relationship with the corresponding member.

According to one preferred embodiment of the method of the present invention, a method is provided for stabilizing a pet dish for holding and presenting pet-related items during ground engagement. The method includes the steps of:
providing a pet dish including a dish body having a base portion and at least one wall member extending from the base portion and defining at least one cavity for containing pet related items;
providing a support member including a generally elongate body for penetrating ground engagement;
providing a fastener assembly including a first fastener portion mounted to the dish and a second fastener portion mounted to the support member in a configuration for mating with the first fastener portion;
driving the support member into the ground to the extent that the second fastener portion is closely adjacent the ground surface;
placing the pet dish over the second fastener portion in a manner wherein the first fastener portion and the second fastener portion are in operational alignment; and
placing the pet dish on the support member in a manner wherein the first fastener portion and the second fastener portion are in a mated relationship.

Preferably, the step of providing a fastener assembly includes providing a fastener assembly wherein the first fastener portion is formed with at least one wall defining a receiving chamber and a cover for covering the receiving chamber, the cover being formed with a keyway therein, and the second fastener body portion includes at least one boss projecting therefrom and configured for selective engagement with the keyway formed in the cover of the first fastener portion for selective retention of the vessel and the stabilizer in a mated relationship and the step of placing the pet dish on the support member in a manner wherein the first fastener portion and the second fastener portion are in a mated relationship includes engaging the at least one boss projecting from the body portion with the keyway formed in the cover of the first fastener portion for selective retention of the dish and the support member in a mated relationship.

It is preferred that the step of providing a fastener assembly includes providing a fastener assembly wherein the first fastener portion is formed with at least one wall defining a receiving chamber, with the at least one wall being formed with at least one slot therein and a second fastener body portion having at least one boss projecting therefrom and configured for selective engagement with the at least one slot formed in the at least one wall of the first fastener portion for selective retention of the dish and the support member in a mated relationship. The step of placing the pet dish on the support member in a manner wherein the first fastener portion and the second fastener portion are in a mated relationship includes engaging the at least one boss projecting from the body portion with the at least one slot formed in the at least one wall of the first fastener portion for selective retention of the dish and the support member in a mated relationship.

Preferably, the step of providing a fastener assembly includes providing a fastener assembly wherein the first fastener portion and the second faster portion are configured for relative rotational motion of about ¼ of a full 360 degree rotation to about ½ of a full 360 degree rotation between the first fastener portion and the second fastener portion and thereby between the dish and the support member and thereby. The step of placing the pet dish on the support member in a manner wherein the first fastener portion and the second fastener portion are in a mated relationship includes moving the first fastener portion relative to the second fastener portion about ¼ of a full 360 degree rotation to about ½ of a full 360 degree rotation between a first position wherein the first fastener portion is engaged with the second fastener portion and second position wherein the first fastener portion and the second fastener portion are retained in a mated relationship, thereby retaining the dish and the support member in a mated relationship.

According to another preferred embodiment thereof, the step of providing a fastener assembly includes providing a fastener assembly wherein the fastener assembly includes a first fastener portion includes at least one wall forming a receiving chamber, with the at least one wall being threaded and a second fastener portion including a body being formed with threads operationally corresponding to the threads formed on the receiving chamber. The step of placing the pet dish on the support member in a manner wherein the first fastener portion and the second fastener portion are in a mated relationship includes mating the threads of the first fastener portion with the threads of the second fastener portion and rotating the dish relative to the support member to operationally engage the first fastener portion and the second fastener portion to threadedly retain the dish and the support member in a mated relationship.

According to another preferred embodiment thereof, the present method includes the step of providing a fastener assembly including providing a fastener assembly wherein a first fastener portion includes a receiving portion formed thereon and the second fastener portion includes a corresponding member configured for receipt by the receiving portion, with at least one magnet being disposed on at least one of the receiving portion and the corresponding member and wherein at least one of the receiving portion and the corresponding member includes a magnetically attractive element. The step of placing the pet dish on the support member in a manner wherein the first fastener portion and the second fastener portion are in a mated relationship includes bringing the first fastener portion into abutment with the second fastener portion for magnetic retention of the first fastener portion with the second fastener portion for selective retention of the pet dish and the support member in a magnetically mated relationship therewith.

### BRIEF DESCRIPTION OF THE DRAWINGS

FIG. 1 is an exploded view of a stabilized pet dish according to one preferred embodiment of the present invention;

FIG. 2 is a perspective view of the fastener assembly according to one preferred embodiment of the present invention;

FIG. 3 is a cutaway view of the stabilized pet dish illustrated in FIG. 1 and taken along lines 3-3 thereof;

FIG. 4 is a side view of the stabilized pet dish illustrated in FIG. 3 shown partially broken open to illustrate a further position of the fastener assembly;

FIG. 5 is an exploded view of a stabilized pet dish according to another preferred embodiment of the present invention;

FIG. 6 is a cutaway view of the stabilized pet dish illustrated in FIG. 5 and taken along lines 5-5 thereof;

FIG. 7 is an operational view of the stabilized pet dish illustrated in FIG. 6 shown partially broken open to illustrate operation of the fastener assembly;

FIG. 8 is a side view of the stabilized pet dish illustrated in FIG. 7 shown partially broken open to illustrate a further position of the fastener assembly;

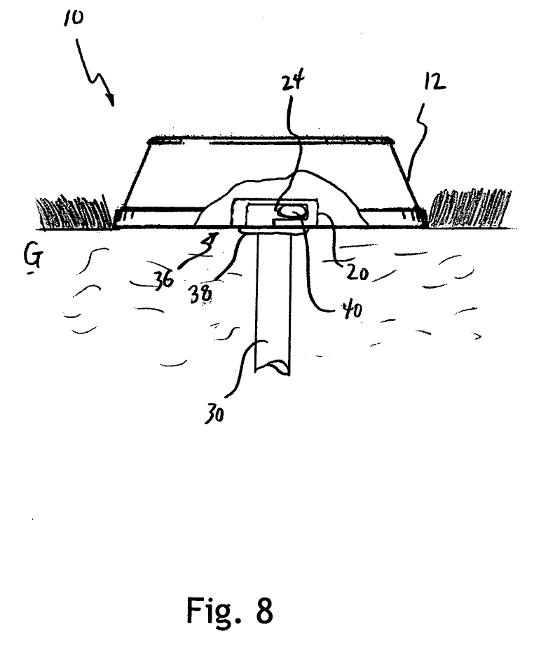

FIG. 9 is a side, cutaway view of the stabilized pet dish of the present invention illustrating another preferred embodiment thereof; and

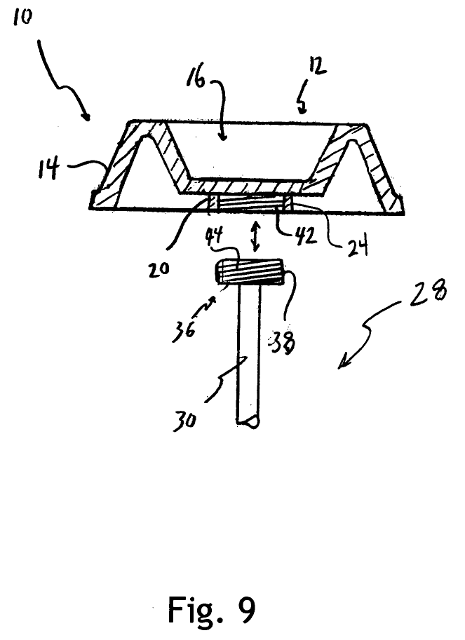

FIG. 10 is a side, cutaway view of the stabilized pet dish illustrating another preferred embodiment thereof.

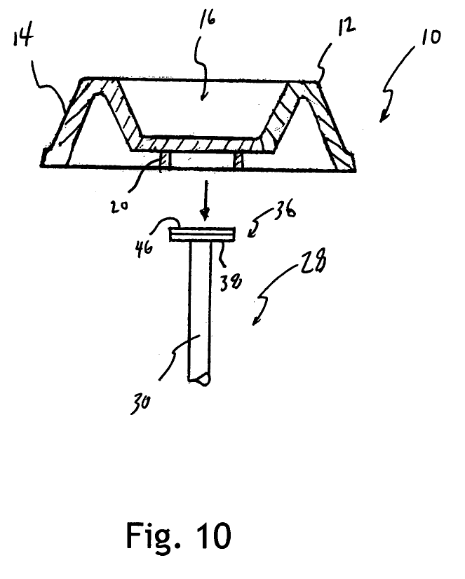

### DESCRIPTION OF THE PREFERRED EMBODIMENT

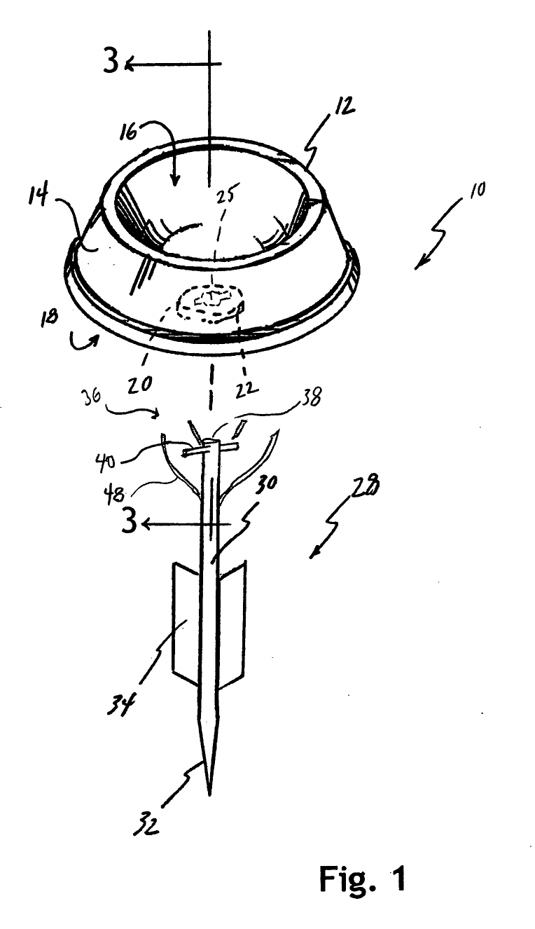

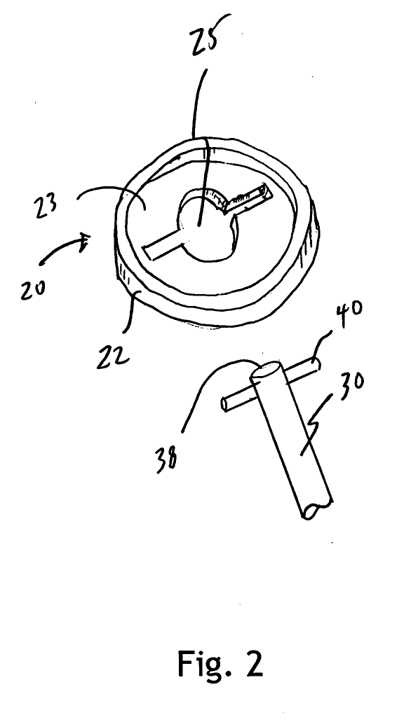

Turning now to the drawings and, more particularly to FIG. 1, a stabilized pet dish is illustrated generally at 10 and includes a dish or vessel 12 having a frusto-conical outer wall curved inwardly to form an inner cavity 16. The dish 12 includes a base portion 18 that is generally circular and planar for ground disposition. It should be noted that the dish 12 can take any number of shapes as long as it defines at least one cavity for receiving pet sustenance items such as water or food therein. Optionally, the dish 12 may be formed with multiple cavities. The dish 12 may be formed of plastic, metal or any other acceptable material. The dish 12 may include a generally planar face portion that extends over the entire surface of the underside of the dish 12 or the dish 12 may be formed from a continuous wall member that is curved and pressed into shape as illustrated in the cutaway view of FIG. 2. Preferably the dish 12 is formed from stainless steel and is pressed into shape.

In order to support and secure the dish 12 in ground engagement, a support member or stabilizer 28 is provided and is formed as a generally elongate shaft 30 having a generally pointed ground piercing tip 32 at one end thereof and a portion of a fastener assembly fitted to the opposite end, as we explained in greater detail hereinafter.

Optionally, a pair of generally planar vanes 34 may project outwardly from the shaft 30 in order to further stabilize the support member 28 when it is inserted in the ground. As it will be appreciated, the vanes 34 will help prevent rotation of the generally cylindrical shaft 30 in the ground when the dish 12 is applied thereto according to the method of the present invention. Optionally, a plurality of upwardly projecting arm members 48 are fitted to the shaft 30 to project upwardly and angularly away therefrom. The arm members 48 terminate at approximately the level of the upper end of the shaft 30 to provide a foot support for the user inserting the support member 28 in the ground using s stepping action. An array of arm members 48 are disposed at periodic intervals around the shaft.

A fastener assembly is provided for mating the dish 12 and the support member 28 in a stabilized manner. With reference to FIG. 2, the fastener assembly includes a first fastener portion 20 including an upstanding wall 22 defining a receiving chamber therein for receiving a second fastener portion 36, as explained in greater detail hereinafter. A keyed cover 23 is provided with a keyway 25 formed therein for accepting receipt of the second fastener portion.

With reference to FIG. 1 and FIG. 2, the second fastener portion 36 is formed on one end of the shaft 30 of the support member 28. The second fastener portion 36 includes a body 38 which is formed in a generally cylindrical manner integral with the shaft, and is configured for receipt in the receiving chamber 21 of the first fastener portion 20 through the keyway 25. In order to be properly aligned and to lock the dish 12 onto the support member 28, a pair of bosses or tabs 40 extend outwardly from either side of the body 38 of the second fastener portion 36. The bosses 40 are configured for entrance into the receiving chamber 21 through the keyway 25.

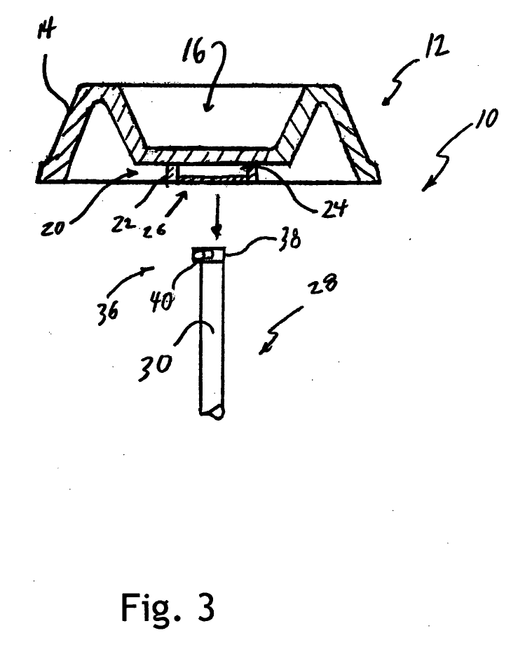

In operation, with reference to FIG. 3 and according to the method of the present invention, the dish 12 is placed onto the support member 28 and locked into position. With reference to FIG. 3, the support member 28 is driven into the ground G using the ground G-penetrating shaft 30 and the tip 32 by pressing on the shaft 30 and the arm members 48, if present. The shaft 30 is driven into the ground G to a position to the extent that the second fastener portion 36 projects from the ground G to the minimum extent required for engagement with the dish. Some experimentation may be required to achieve the height relationship, although the dish 12 may be fitted to the shaft 30 at a position above the ground G and then the entire assembly driven toward the ground G. When the dish 12 rests on the ground G, the shaft 30 is at the correct depth. Importantly, the second fastener assembly 36 may be maintained at a height that is below the height of a rotating lawnmower blade so that the support member 28 may remain in the ground G while grooming operations are performed on the surrounding area.

Once the shaft 30 is in the ground G, the dish 12 is placed over the support member 28 in a manner wherein the bosses 40 extend through the keyway 25 into the receiving chamber 21. The dish 12 is then rotated through a predetermined angular displacement which is preferably ¼ turn. It will be understood by those skilled in the art that the term ¼ turn refers to ¼ of a 360 degree rotation. Lesser or greater turn amounts may be incorporated in the present invention without deviating from the spirit and scope thereof.

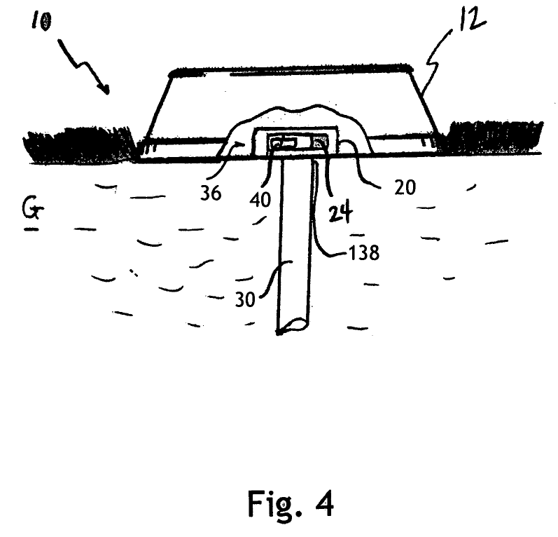

With reference to FIG. 4, the dish 12 has been rotated through the predetermined amount and the bosses 40 rotated out of alignment with the keyway 25, thereby locking the first fastener portion 20 and the second fastener portion 36 in a mated relationship and retaining the dish on the ground G in a manner that resists removal of the dish 12 without further horizontal rotation in the opposite direction. The dish 12 can therefore be considered locked to the ground G and therefore resistant to overturning.

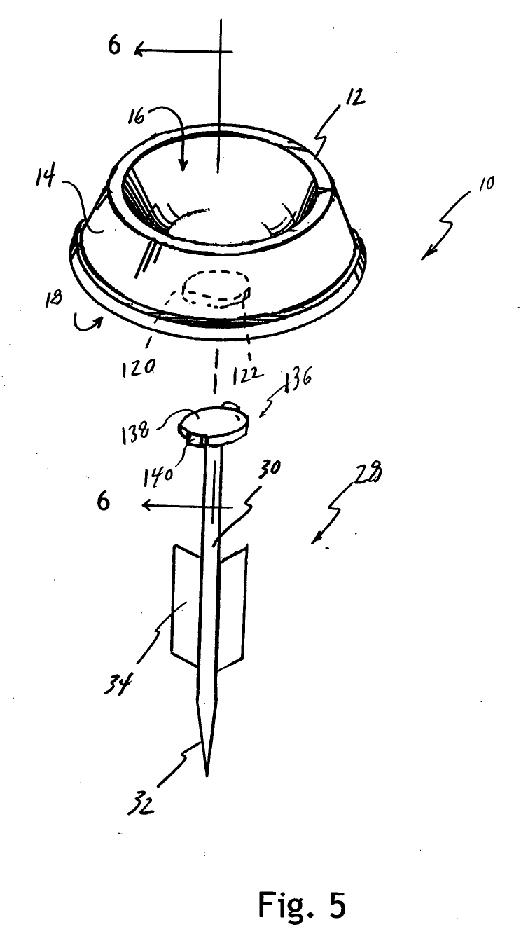

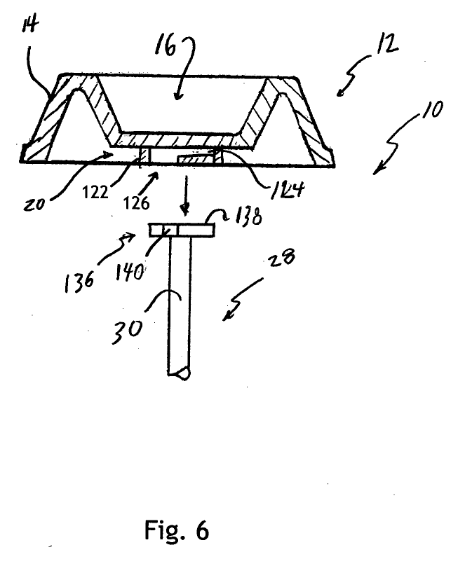

According to another preferred embodiment of the present invention and with reference to FIG. 5, another fastener assembly is provided for mating the dish 12 and the support member 28 in a stabilized manner. With continued reference to FIG. 5, the fastener assembly includes a first fastener portion 120 including an upstanding wall 122 defining a receiving chamber therein for receiving a second fastener portion 36, as explained in greater detail hereinafter. The wall member 122 includes a pair of slots 124 formed therein, each extending approximately 90° around the circumference of the wall 122. A single slot is illustrated in the drawings for clarity. An entrance 126 to the slot is provided in the wall 122, as seen in FIG. 6.

With reference to FIG. 5 and FIG. 6, the second fastener portion 136 is formed on one end of the shaft 30 of the support member 28. The second fastener portion 136 includes a body 38 which is formed in a generally cylindrical manner and is configured for receipt in the receiving chamber 121 of the first fastener portion 120. In order to be properly aligned and to lock the dish 12 onto the support member 28, a pair of bosses or tabs 140 extend outwardly from either side of the body of the second fastener portion 136. The bosses 140 are configured for entrance into the slot 124 through the entrance 126.

In operation and according to another preferred embodiment of the method of the present invention, the dish 12 is placed onto the support member 28 and locked into position. With reference to FIG. 6, the support member 28 is driven into the ground G using the ground G-penetrating shaft 30 and the tip 32. The shaft 30 is driven into the ground G to a position to the extent that the second fastener portion 136 projects from the ground G to the minimum extent required for engagement with the dish, as discussed above with reference to the first preferred embodiment of the present invention.

Once the shaft 30 is in the ground G, the dish 12 is placed over the support member 28 in a manner wherein the bosses 140 extend into the entrances 126 to the receiving chamber 121. The dish 12 is then rotated through a predetermined angular displacement which is preferably between ¼ turn and ½ turn. It will be understood by those skilled in the art that the terms ¼ turn and ½ turn refer to ¼ of a 360 degree rotation and ½ of a 360 degree rotation, respectively. Lesser or greater turn amounts may be incorporated in the present invention without deviating from the spirit and scope thereof.

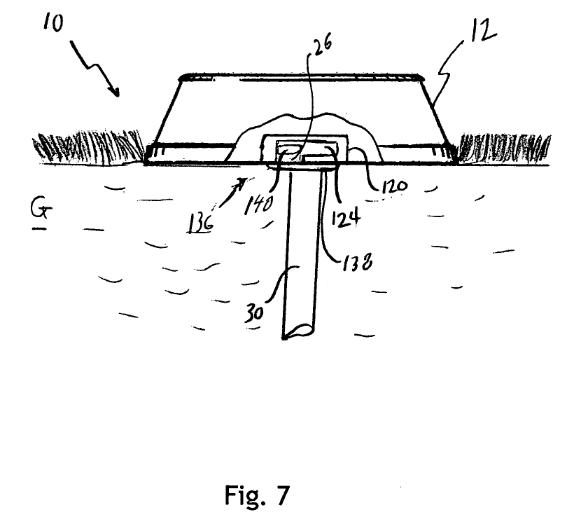

With reference to FIG. 7, the dish 12 has been rotated through the predetermined amount and the bosses 140 are engaged fully with the slot 124, thereby locking the first fastener portion 120 and the second fastener portion 36 in a mated relationship and retaining the dish on the ground G in a manner that resists removal of the dish 12 without further horizontal rotation in the opposite direction. The dish 12 can therefore be considered locked to the ground G and therefore resistant to overturning.

Another preferred embodiment of the present invention eliminates the foregoing bayonet connector by the use of conventional screw threads. As seen in FIG. 5, the walls 24 of the first fastener portion 20 are formed with screw threads on an internal portion thereof. Corresponding threads 44 are formed on the body 38 of the second fastener portion 36.

In operation, the dish 12 is placed on the shaft 30 with the second shaft portion 36 threadedly engaged with the first fastener portion 20 such that the threads 44 on the second fastener portion 36 operationally engage the threads 42 on the first fastener portion 20. Rotation of the dish 12 through multiple forward rotations is required for complete engagement of the dish 12 with the shaft 30.

One advantage of the threaded-type connector is that the length of the body portion 38 may be varied such that the depth of penetration of the shaft 30 is more variable than with the bayonet-type connector. It should be noted however, that the threaded body portion 38 should not project beyond the level at which it would engage a mower blade during grooming operations of the surrounding area.

According to another preferred embodiment of the present invention, and with reference to FIG. 6, a magnet 46 is attached to the second fastener portion 36 and projects upwardly from the body portion 38 thereof. As before, the body portion 38 of the second fastener portion 36 is configured for fitment within the wall 22 defining the receiving chamber of the first fastener portion 20. A magnetically attractive element may be mounted within the first fastener portion 20 or the walls 14 forming the dish 12 may be formed from a magnetically attractive metallic material. Alternately, the magnet may be attached to the dish 12 and the magnetically attractive element may be mounted to the second fastener portion 36 or the second fastener portion 36 may be formed from a magnetically attractive metallic material.

In operation, the dish 12 is placed onto the support member 28 such that the body 38 and magnet 46 of the second fastener portion 36 is received by the first fastener portion 20 and the magnetic attraction between either the walls 14 of the dish 12 or the magnetically attractive element (not shown) retains the dish in place on the ground G. An advantage of this embodiment is that no rotation of the dish 12 is required for mating with the support member. Therefore, placing the dish on the ground G in a stabilized manner can occur more rapidly than with the bayonet connector version or the threaded version of the present invention.

By the above, the present invention provides a stabilized pet dish for outdoor use that can function essentially as a conventional pet dish in that it can be removed from the ground and used indoors, cleaned or refilled and returned to the outdoor position and locked into place on the ground without movement of the support member which remains in the ground throughout. There should be no reason to remove the support member from the ground and therefore, the present stabilized pet dish provides ease of use that has been heretofore unobtainable with past stabilized pet dishes.

It will therefore be readily understood by those persons skilled in the art that the present invention is susceptible of a broad utility and application. While the present invention is described in all currently foreseeable embodiments, there may be other, unforeseeable embodiments and adaptations of the present invention, as well as variations, modifications and equivalent arrangements, that do not depart from the substance or scope of the present invention. The foregoing disclosure is not intended or to be construed to limit the present invention or otherwise to exclude such other embodiments, adaptations, variations, modifications and equivalent arrangements, the present invention being limited only by the claims appended hereto and the equivalents thereof.

I claim:

1. A vessel for holding and presenting solids, liquids or both, the vessel comprising:
a vessel body having a base portion and at least one wall member extending from the base portion and defining at least one cavity for containing solids, liquids or both;
a stabilizer including a stabilizer body for ground engagement; and
a fastener assembly for releasably retaining the body and the stabilizer in a mated relationship, the fastener including a first fastener portion mounted to the vessel body and a second fastener portion mounted to the stabilizer in a configuration for mating with the first fastener portion when the second fastener portion is closely adjacent a ground surface with the stabilizer body extending into the ground.

2. A vessel according to claim 1 wherein the first fastener portion includes a receiving chamber formed therein and the second fastener portion includes a body portion configured for receipt in the receiving chamber, with the receiving chamber configured for selective retention of the body portion in a mated relationship therewith.

3. A vessel according to claim 2 wherein the first fastener portion is formed with at least one wall defining the receiving chamber and a cover for covering the receiving chamber, the cover being formed with a keyway therein, and the second fastener body portion includes at least one boss projecting therefrom and configured for selective engagement with the keyway formed in the cover of the first fastener portion for selective retention of the vessel and the stabilizer in a mated relationship.

4. A vessel according to claim 2 wherein the first fastener portion is formed with at least one wall defining the receiving chamber, with the at least one wall being formed with at least one slot therein and the second fastener body portion includes at least one boss projecting therefrom and configured for selective engagement with the at least one slot formed in the at least one wall of the first fastener portion for selective retention of the vessel and the stabilizer in a mated relationship.

5. A vessel according to claim 4 wherein the first fastener portion and the second faster portion are configured for engagement with one another by relative rotational motion of the first fastener portion and the second fastener portion between a first position wherein the first fastener portion is engaged with the second fastener portion and a second position wherein the first fastener portion and the second fastener portion are retained in a mated relationship, thereby retaining the vessel and the stabilizer in a mated relationship.

6. A vessel according to claim 5 wherein the first fastener portion and the second faster portion are configured for relative rotational motion of about ¼ of a full 360 degree rotation to about ½ of a full 360 degree rotation of the vessel with respect to the stabilizer and thereby the first fastener portion with respect to the second fastener portion that results in the first fastener portion and the second fastener portion experiencing relative movement between a first position wherein the first fastener portion is engaged with the second fastener portion and a second position wherein the first fastener portion and the second fastener portion are retained in a mated relationship, thereby retaining the vessel and the stabilizer in a mated relationship.

7. A vessel according to claim 1 wherein the first fastener portion includes at least one wall forming a receiving chamber therein, with the at least one wall being threaded and the second fastener portion includes a fastener body being formed with threads operationally corresponding to the threads formed on the receiving chamber, with the receiving chamber being configured for selective retention of the fastener body in a threadedly mated relationship therewith.

8. A vessel according to claim 1 wherein the fastener assembly includes a first fastener portion having a receiving portion formed thereon and the second fastener portion includes a corresponding member configured for receipt by the receiving portion, with at least one magnet being disposed on at least one of the receiving portion and the corresponding member, and wherein at least one of the receiving portion and the corresponding member includes a magnetically attractive element for selective retention of the receiving portion in a magnetically mated relationship with the corresponding member.

9. A pet dish for holding and presenting pet-related items, the pet dish being generally for outdoor disposition, the pet dish comprising;
a dish body having a base portion and at least one wall member extending from the base portion and defining at least one cavity for containing pet related items;
a support member including a generally elongate body for penetrating ground engagement; and
a fastener assembly for releasably retaining the dish and the support member in a mated relationship, the fastener including a first fastener portion mounted to the dish and a second fastener portion mounted to the support member in a configuration for mating with the first fastener portion when the second fastener portion is closely adjacent a ground surface with the support member extending into the ground.

10. A pet dish according to claim 9 wherein the fastener assembly includes a first fastener portion having a receiving chamber formed therein and the second fastener portion includes a body portion configured for receipt in the receiving chamber, with the receiving chamber configured for selective retention of the body portion in a mated relationship therewith.

11. A vessel according to claim 10 wherein the first fastener portion is formed with at least one wall defining the receiving chamber and a cover for covering the receiving chamber, the cover being formed with a keyway therein, and the second fastener body portion includes at least one boss projecting therefrom and configured for selective engagement with the keyway formed in the cover of the first fastener portion for selective retention of the vessel and the stabilizer in a mated relationship.

12. A pet dish according to claim 11 wherein the first fastener portion is formed with at least one wall defining the receiving chamber, with the at least one wall being formed with at least one slot therein and the second fastener body portion at least one boss projecting therefrom and configured for selective engagement with the at least one slot formed in the at least one wall of the first fastener portion for selective retention of the vessel and the stabilizer in a mated relationship.

13. A pet dish according to claim 12 wherein the first fastener portion and the second faster portion are configured for engagement with one another by relative rotational motion of the first fastener portion and the second fastener portion between a first position wherein the first fastener portion is engaged with the second fastener portion and a second position wherein the first fastener portion and the second fastener portion are retained in a mated relationship, wherein the vessel and the stabilizer are retained in a mated relationship.

14. A pet dish according to claim 13 wherein the first fastener portion and the second faster portion are configured for relative rotational motion of about ¼ of a full 360 degree rotation to about ½ of a full 360 degree rotation between the vessel and the stabilizer and thereby the first fastener portion and the second fastener portion that results in the first fastener portion and the second fastener portion experiencing relative movement between a first position wherein the first fastener portion is engaged with the second fastener portion and a second position wherein the first fastener portion and the second fastener portion are retained in a mated relationship, thereby retaining the dish and the support member in a mated relationship.

15. A pet dish according to claim 9 wherein the fastener assembly includes a first fastener portion having at least one wall forming a receiving chamber therein, with the at least one wall being threaded and a second fastener portion including a fastener body being formed with threads operationally corresponding to the threads formed on the receiving chamber, with the receiving chamber configured for selective retention of the fastener body in a threadedly mated relationship therewith.

16. A pet dish according to claim 9 wherein the fastener assembly includes a first fastener portion having a receiving portion formed thereon and the second fastener portion includes a corresponding member configured for receipt by the receiving portion, with at least one magnet being disposed on at least one of the receiving portion and the corresponding member and wherein at least one of the receiving portion and the corresponding member includes a magnetically attractive element for selective retention of the receiving portion in a magnetically mated relationship with the corresponding member.

18. A method for stabilizing a pet dish for holding and presenting pet-related items during ground engagement comprising the steps of:
providing a pet dish including a dish body having a base portion and at least one wall member extending from the base portion and defining at least one cavity for containing pet related items;
providing a support member including a generally elongate body for penetrating ground engagement;
providing a fastener assembly including a first fastener portion mounted to the dish and a second fastener portion mounted to the support member in a configuration for mating with the first fastener portion;
driving the support member into the ground to the extent that the second fastener portion is closely adjacent the ground surface;
placing the pet dish over the second fastener portion in a manner wherein the first fastener portion and the second fastener portion are in operational alignment; and
placing the pet dish on the support member in a manner wherein the first fastener portion and the second fastener portion are in a mated relationship.

19. A method for stabilizing a pet dish according to claim 18 wherein:
the step of providing a fastener assembly includes providing a fastener assembly wherein the first fastener portion is formed with at least one wall defining the receiving chamber and a cover for covering the receiving chamber, the cover being formed with a keyway therein, and the second fastener body portion includes at least one boss projecting therefrom and configured for selective engagement with the keyway formed in the cover of the first fastener portion for selective retention of the vessel and the stabilizer in a mated relationship and
the step of placing the pet dish on the support member in a manner wherein the first fastener portion and the second fastener portion are in a mated relationship includes engaging the at least one boss projecting from the body portion with the keyway formed in the cover of the first fastener portion for selective retention of the dish and the support member in a mated relationship.

20. A method for stabilizing a pet dish according to claim 18 wherein:
the step of providing a fastener assembly includes providing a fastener assembly wherein the first fastener portion is formed with at least one wall defining a receiving chamber, with the at least one wall being formed with at least one slot therein and a second fastener body portion having at least one boss projecting therefrom and configured for selective engagement with the at least one slot formed in the at least one wall of the first fastener portion for selective retention of the dish and the support member in a mated relationship; and
the step of placing the pet dish on the support member in a manner wherein the first fastener portion and the second fastener portion are in a mated relationship includes engaging the at least one boss projecting from the body portion with the at least one slot formed in the at least one wall of the first fastener portion for selective retention of the dish and the support member in a mated relationship.
